(19) United States
(12) Patent Application Publication
(10) Pub. No.: US 2006/0106175 A1
(43) Pub. Date: May 18, 2006

(54) Highly neutralized acid polymer compositions having a low moisture vapor transmission rate and their use in golf balls

(76) Inventors: Murali Rajagopalan, South Dartmouth, MA (US); Michael J. Sullivan, Barrington, RI (US)

Correspondence Address: ACUSHNET COMPANY, 333 BRIDGE STREET, P. O. BOX 965, FAIRHAVEN, MA, 02719, US

(21) Appl. No.: 11/270,066

(22) Filed: Nov. 9, 2005

Related U.S. Application Data
(63) Continuation-in-part of application No. 10/959,751, filed on Oct. 6, 2004.
Application No. 10/959,751 is a continuation-in-part of application No. 10/360,233, filed on Feb. 6, 2003, now Pat. No. 6,939,907.
Application No. 10/360,233 is a continuation-in-part of application No. 10/118,719, filed on Apr. 9, 2002, now Pat. No. 6,756,436.
(60) Provisional application No. 60/301,046, filed on Jun. 26, 2001.

(51) Int. Cl. C08F 8/44; C08F 8/00

(52) U.S. Cl. 525/386

(57) ABSTRACT

The present invention is directed to a golf ball having at least one layer formed from a polymer composition which has a moisture vapor transmission rate of 8 g-mil/100 in²/day or less and comprises a highly neutralized acid polymer. Golf balls of the present invention include one-piece, two-piece, multi-layer, and wound golf balls. The composition may be present in any one or more of a core layer, a cover layer, or an intermediate layer.

### CROSS-REFERENCE TO RELATED APPLICATIONS

This application is a continuation-in-part of co-pending U.S. application Ser. No. 10/959,751, filed Oct. 6, 2004, which is a continuation-in-part of co-pending U.S. application Ser. No. 10/360,233, filed Feb. 6, 2003, which is a continuation-in-part of U.S. application Ser. No. 10/118,719, filed Apr. 9, 2002, now U.S. Pat. No. 6,756,436, which claims priority to U.S. Provisional Application No. 60/301,046, filed Jun. 26, 2001, now abandoned, the entire disclosures of which are hereby incorporated herein by reference.

### FIELD OF THE INVENTION

The present invention is directed to polymer compositions having a moisture vapor transmission rate of 8 g-mil/100 in²/day or less and comprising a highly neutralized acid polymer. The present invention is also directed to the use of such compositions in golf balls.

### BACKGROUND OF THE INVENTION

Conventional golf balls can be divided into two general classes: solid and wound. Solid golf balls include one-piece, two-piece (i.e., solid core and a cover), and multi-layer (i.e., solid core of one or more layers and/or a cover of one or more layers) golf balls. Wound golf balls typically include a solid, hollow, or fluid-filled center, surrounded by a tensioned elastomeric material, and a cover.

Golf ball core and cover layers are typically constructed with polymer compositions including, for example, polybutadiene rubber, polyurethanes, polyamides, ionomers, and blends thereof. Ionomers, particularly highly neutralized ionomers, are a preferred group of polymers for golf ball layers because of their toughness, durability, and wide range of hardness values. However, conventional highly neutralized ionomers are hydrophilic, due to the highly hydrophilic nature of the cation sources traditionally used to neutralize the ionomers, e.g., magnesium and magnesium salts of fatty acids. As a result of their hydrophilic nature, conventional highly neutralized ionomers can absorb a significant amount of moisture, e.g., 2,000 to 10,000 parts per million (ppm), which can result in processing difficulties, such as creating voids in the part during an injection molding process, and a reduction in golf ball performance, such as decreased coefficient of restitution (“COR”) and stiffness due to the plasticization of ionic aggregates by water molecules.

Therefore, a desire remains for compositions containing highly neutralized acid polymers having improved moisture vapor transmission properties. The present invention describes such compositions and the use thereof in a variety of golf ball core and cover layers.

### SUMMARY OF THE INVENTION

In one embodiment, the present invention is directed to a golf ball having at least one layer formed from a polymer composition having a moisture vapor transmission rate of 8 g-mil/100 in²/day or less. The polymer composition comprises a highly neutralized acid polymer.

In another embodiment, the present invention is directed to a golf ball having at least one layer formed from a polymer composition having a moisture vapor transmission rate of 5 g-mil/100 in²/day or less. The polymer composition comprises an ethylene/(meth) acrylic acid copolymer in an amount of at least 30 wt %, based on the total polymeric weight of the polymer composition. At least 90% of the acid groups of the acid copolymer are neutralized.

### DETAILED DESCRIPTION OF THE INVENTION

Golf balls of the present invention include one-piece, two-piece, multi-layer, and wound golf balls having a variety of core structures, intermediate layers, covers, and coatings. Golf ball cores may consist of a single, unitary layer, comprising the entire core from the center of the core to its outer periphery, or they may consist of a center surrounded by at least one outer core layer. The center, innermost portion of the core is preferably solid, but may be hollow or liquid-, gel-, or gas-filled. The outer core layer may be solid, or it may be a wound layer formed of a tensioned elastomeric material. Golf ball covers may also contain one or more layers, such as a double cover having an inner and outer cover layer. Optionally, additional layers may be disposed between the core and cover. In the golf balls of the present invention, at least one layer is formed from a polymer composition having a moisture vapor transmission rate of 8 g-mil/100 in²/day or less and comprising a highly neutralized acid polymer (“HNP”). In a preferred embodiment, the polymer composition of the present invention is present in the outer core layer of a multi-layer golf ball.

As used herein, “highly neutralized acid polymer” refers to the acid polymer after at least 70%, preferably at least 80%, more preferably at least 90%, even more preferably at least 95%, and even more preferably 100%, of the acid groups thereof are neutralized. By the present invention, it has been found that when an acid polymer or a partially neutralized acid polymer is neutralized to 70% or higher using a cation source which is less hydrophilic than magnesium-based cation sources traditionally used to produce HNPs, the resulting inventive HNP provides for compositions having improved moisture vapor transmission properties. For example, a polymer composition comprising an HNP, wherein the HNP is produced using a less hydrophilic cation source, can have a moisture vapor transmission rate of 8 g-mil/100 in²/day or less, or 5 g-mil/100 in²/day or less, or 3 g-mil/100 in²/day or less, or 2 g-mil/100 in²/day or less, or 1 g-mil/100 in²/day or less, or less than 1 g-mil/100 in²/day. As used herein, moisture vapor transmission rate (MVTR) is given in g-mil/100 in²/day, and is measured at 20° C., and according to ASTM F1249-99.

“Less hydrophilic” is used herein to refer to cation sources which are less hydrophilic than conventional magnesium-based cation sources. The HNPs of the present invention are produced using one or more of such less hydrophilic cation sources. Examples of suitable less hydrophilic cation sources include, but are not limited to, silicone, silane, and silicate derivatives and complex ligands; metal ions and compounds of rare earth elements; and less hydrophilic metal ions and compounds of alkali metals, alkaline earth metals, and transition metals; and combinations thereof. Particular less hydrophilic cation sources include, but are not limited to, metal ions and compounds of potassium, cesium, calcium, barium, manganese, copper, zinc, tin, and rare earth metals. Potassium-based compounds are a preferred less hydrophilic cation source, and particularly Oxone®, commercially available from E.I. du Pont de Nemours and Company. Oxone® is a monopersulfate compound wherein potassium monopersulfate is the active ingredient present as a component of a triple salt of the formula 2KHSO₅.KHSO₄.K₂SO₄ [potassium hydrogen peroxymonosulfate sulfate (5:3:2:2)]. The amount of less hydrophilic cation source used is readily determined based on the desired level of neutralization.

The highly neutralized acid polymers of the present invention are salts of homopolymers and copolymers of α,β-ethylenically unsaturated mono- or dicarboxylic acids, and combinations thereof. The term “copolymer,” as used herein, includes polymers having two types of monomers, those having three types of monomers, and those having more than three types of monomers. Preferred acids are (meth) acrylic acid, ethacrylic acid, maleic acid, crotonic acid, fumaric acid, itaconic acid. (Meth) acrylic acid is particularly preferred. As used herein, “(meth) acrylic acid” means methacrylic acid and/or acrylic acid. Likewise, “(meth) acrylate” means methacrylate and/or acrylate. Preferred acid polymers are copolymers of a C₃ to C₈ α,β-ethylenically unsaturated mono- or dicarboxylic acid and ethylene or a C₃ to C₆ α-olefin, optionally including a softening monomer. Particularly preferred acid polymers are copolymers of ethylene and (meth) acrylic acid.

When a softening monomer is included, the acid polymer is referred to herein as an E/X/Y-type copolymer, wherein E is ethylene, X is a C₃ to C₈ α,β-ethylenically unsaturated mono- or dicarboxylic acid, and Y is a softening monomer. The softening monomer is typically an alkyl (meth) acrylate, wherein the alkyl groups have from 1 to 8 carbon atoms. Preferred E/X/Y-type copolymers are those wherein X is (meth) acrylic acid and/or Y is selected from (meth) acrylate, n-butyl (meth) acrylate, isobutyl (meth) acrylate, methyl (meth) acrylate, and ethyl (meth) acrylate. More preferred E/X/Y-type copolymers are ethylene/(meth) acrylic acid/n-butyl acrylate, ethylene/(meth) acrylic acid/methyl acrylate, and ethylene/(meth) acrylic acid/ethyl acrylate.

The amount of ethylene or C₃ to C₆ α-olefin in the acid copolymer is typically at least 15 wt %, preferably at least 25 wt %, more preferably least 40 wt %, and even more preferably at least 60 wt %, based on the total weight of the copolymer. The amount of C₃ to C₈ α,β-ethylenically unsaturated mono- or dicarboxylic acid in the acid copolymer is typically from 1 wt % to 35 wt %, preferably from 4 wt % to 35 wt %, more preferably from 6 wt % to 35 wt %, and even more preferably from 8 wt % to 20 wt %, based on the total weight of the copolymer. The amount of optional softening comonomer in the acid copolymer is typically from 0 wt % to 50 wt %.

Suitable acid polymers also include partially neutralized acid polymers. Examples of suitable partially neutralized acid polymers include, but are not limited to, Surlyn® ionomers, commercially available from E.I. du Pont de Nemours and Company; AClyn® ionomers, commercially available from Honeywell International Inc.; and Iotek® ionomers, commercially available from ExxonMobil Chemical Company. Additional suitable acid polymers are more fully described, for example, in U.S. Pat. No. 6,953,820 and U.S. Patent Application Publication No. 2005/0049367, the entire disclosures of which are hereby incorporated herein by reference.

The acid polymers of the present invention can be direct copolymers wherein the polymer is polymerized by adding all monomers simultaneously, as described in, for example, U.S. Pat. No. 4,351,931, the entire disclosure of which is hereby incorporated herein by reference. Ionomers can be made from direct copolymers, as described in, for example, U.S. Pat. No. 3,264,272 to Rees, the entire disclosure of which is hereby incorporated herein by reference. Alternatively, the acid polymers of the present invention can be graft copolymers wherein a monomer is grafted onto an existing polymer, as described in, for example, U.S. Patent Application Publication No. 2002/0013413, the entire disclosure of which is hereby incorporated herein by reference.

Compositions of the present invention include at least one inventive HNP (i.e., produced using a less hydrophilic cation source), and optionally include one or more additional HNP(s). When included, the additional HNP(s) can be one or more inventive HNP(s) and/or one or more conventional HNP(s) (i.e., produced using a conventional cation source). The total amount of HNP(s) in the composition is preferably at least 30 wt %, more preferably at least 50 wt %, even more preferably from 50 wt % to 99.5 wt %, and even more preferably from 60 wt % to 98 wt %, based on the total polymeric weight of the composition. Preferably, the amount of inventive HNP(s) present in the composition is at least 30 wt %.

In order to be processable, the HNP-containing composition of the present invention has a melt flow index of at least 0.5 g/10 min. Preferably, the melt flow index of the HNP-containing composition is from 0.5 g/10 min to 10.0 g/10 min, more preferably from 1.0 g/10 min to 5.0 g/10 min, and even more preferably from 1.0 g/10 min to 4.0 g/10 min.

Compositions of the present invention may optionally contain one or more melt flow modifier(s). Suitable melt flow modifiers include organic acids and salts thereof, polyamides, polyesters, polyacrylates, polyurethanes, polyethers, thermoplastic polyureas, polyhydric alcohols, and combinations thereof. Suitable organic acids are aliphatic organic acids, aromatic organic acids, saturated mono-functional organic acids, unsaturated monofunctional organic acids, multi-unsaturated mono-functional organic acids, and dimerized derivatives thereof. Particular examples of suitable organic acids include, but are not limited to, caproic acid, caprylic acid, capric acid, lauric acid, stearic acid, behenic acid, erucic acid, oleic acid, linoleic acid, myristic acid, benzoic acid, palmitic acid, phenylacetic acid, naphthalenoic acid, dimerized derivatives thereof. When one or more organic acid salt(s) are included in compositions of the present invention, the cation source used to produce the organic acid salt(s) is preferably a less hydrophilic cation source. Suitable organic acids are more fully described, for example, in U.S. Pat. No. 6,756,436, the entire disclosure of which is hereby incorporated herein by reference.

Additional non-fatty acid melt flow modifiers, suitable for use in compositions of the present invention, include those described in copending U.S. patent application Ser. Nos. 11/216,725 and 11/216,726, the entire disclosures of which are hereby incorporated herein by reference.

Compositions of the present invention may optionally contain one or more additives in an amount of from 0 wt % to 60 wt %, based on the total weight of the composition. Suitable additives include, but are not limited to, chemical blowing and foaming agents, optical brighteners, coloring agents, fluorescent agents, whitening agents, UV absorbers, light stabilizers, defoaming agents, processing aids, mica, talc, nano-fillers, antioxidants, stabilizers, softening agents, fragrance components, plasticizers, impact modifiers, TiO₂, acid copolymer wax, surfactants, and fillers, such as zinc oxide, tin oxide, barium sulfate, zinc sulfate, calcium oxide, calcium carbonate, zinc carbonate, barium carbonate, clay, tungsten, tungsten carbide, silica, lead silicate, regrind (recycled material), and mixtures thereof. Suitable additives are more fully described in, for example, U.S. Patent Application Publication No. 2003/0225197, the entire disclosure of which is hereby incorporated herein by reference.

Compositions may optionally be produced by blending the HNP of the present invention with one or more additional polymers, such as thermoplastic polymers and elastomers. Examples of thermoplastic polymers suitable for blending with the invention HNPs include, but are not limited to, polyolefins, polyamides, polyesters, polyethers, polycarbonates, polysulfones, polyacetals, polylactones, acrylonitrile-butadiene-styrene resins, polyphenylene oxide, polyphenylene sulfide, styrene-acrylonitrile resins, styrene maleic anhydride, polyimides, aromatic polyketones, ionomers and ionomeric precursors, acid copolymers, conventional HNPs, polyurethanes, grafted and non-grafted metallocene-catalyzed polymers, single-site catalyst polymerized polymers, high crystalline acid polymers, cationic ionomers, and combinations thereof. Particular polyolefins suitable for blending include one or more, linear, branched, or cyclic, C₂-C₄₀ olefins, particularly polymers comprising ethylene or propylene copolymerized with one or more C₂-C₄₀ olefins, C₃-C₂₀ α-olefins, or C₃-C₁₀ α-olefins. Particular conventional HNPs suitable for blending include, but are not limited to, one or more of the HNPs disclosed in U.S. Pat. Nos. 6,756,436, 6,894,098, and 6,953,820, the entire disclosures of which are hereby incorporated herein by reference. Examples of elastomers suitable for blending with the invention polymers include all natural and synthetic rubbers, including, but not limited to, ethylene propylene rubber (“EPR”), ethylene propylene diene rubber (“EPDM”), styrenic block copolymer rubbers (such as SI, SIS, SB, SBS, SIBS, and the like, where “S” is styrene, “I” is isobutylene, and “B” is butadiene), butyl rubber, halobutyl rubber, copolymers of isobutylene and para-alkylstyrene, halogenated copolymers of isobutylene and para-alkylstyrene, natural rubber, polyisoprene, copolymers of butadiene with acrylonitrile, polychloroprene, alkyl acrylate rubber, chlorinated isoprene rubber, acrylonitrile chlorinated isoprene rubber, and polybutadiene rubber (cis and trans). Additional suitable blend polymers include those described in U.S. Pat. No. 5,981,658, for example at column 14, lines 30 to 56, the entire disclosure of which is hereby incorporated herein by reference. The blends described herein may be produced by post-reactor blending, by connecting reactors in series to make reactor blends, or by using more than one catalyst in the same reactor to produce multiple species of polymer. The polymers may be mixed prior to being put into an extruder, or they may be mixed in an extruder.

Compositions of the present invention typically have a flexural modulus of from 3,000 psi to 200,000 psi, preferably from 5,000 psi to 150,000 psi, more preferably from 10,000 psi to 125,000 psi, and even more preferably from 10,000 psi to 100,000 psi. The material hardness of the composition is generally from 30 Shore D to 80 Shore D. In embodiments wherein the composition is present in a golf ball center, the composition preferably has a material hardness of from 30 Shore D to 50 Shore D. In embodiments wherein the composition is present in a golf ball cover layer, an outer core layer, or an intermediate layer disposed between the core and the cover, the composition preferably has a material hardness of from 30 Shore D to 70 Shore D. The notched izod impact strength of the compositions of the present invention is generally at least 2 ft·lb/in, as measured at 23° C. according to ASTM D256.

The present invention is not limited by any particular method or any particular equipment for making the composition. In a preferred embodiment, the composition is prepared by the following process. An acid polymer, preferably ethylene/(meth) acrylic acid, is fed into a melt extruder, such as a single or twin screw extruder. A suitable amount of a less hydrophilic cation source is added to the molten acid polymer. The acid polymer may be partially neutralized prior to contact with the cation source, preferably with a cation source selected from metal ions and compounds of calcium, magnesium, and zinc. The acid polymer/cation mixture is intensively mixed prior to being extruded as a strand from the die-head. Optionally, a less hydrophilic cation source based on a fatty acid salt or other non-fatty acid salt melt flow modifier is incorporated during the HNP production. In a particular aspect of this embodiment, the ethylene/(meth) acrylic acid copolymer is selected from Nucrel® acid copolymers, commercially available from E.I. du Pont de Nemours and Company (such as Nucrel® 960, an ethylene/methacrylic acid copolymer) and Primacor® polymers, commercially available from Dow Chemical Company (such as Primacor® XUS 60758.08L and XUS60751.18, ethylene/acrylic acid copolymers containing 13.5% and 15.0% acid, respectively).

Compositions of the present invention can be used in a variety of applications. For example, HNP-containing compositions are suitable for use in golf equipment, including, but not limited to, golf balls, golf shoes, and golf clubs.

Golf balls of the present invention can be wound, one-piece, two-piece, or multi-layer balls, wherein at least one layer is formed from a composition comprising an HNP produced using a less hydrophilic cation source. In golf balls having two or more layers which comprise an HNP of the present invention, the inventive HNP of one layer may be the same or a different inventive HNP as another layer. The layer(s) comprising the HNP of the present invention can be any one or more of a core layer (such as a center or an outer core layer), an intermediate layer, or a cover layer. Compositions of the present invention can be either foamed or filled with density adjusting materials to provide desirable golf ball performance characteristics.

The present invention is not limited by any particular process for forming the golf ball layer(s). It should be understood that the layer(s) can be formed by any suitable technique, including injection molding, compression molding, casting, and reaction injection molding.

In a preferred embodiment, the present invention provides a multi-layer golf ball having a compression molded rubber core, at least one injection or compression molded intermediate layer which comprises an HNP produced using a less hydrophilic cation source, and a polyurethane or polyurea outer cover layer. The polyurethane or polyurea outer cover layer material can be thermoset or thermoplastic. Thermoset materials can be formed into golf ball layers by conventional casting or reaction injection molding techniques. Thermoplastic materials can be formed into golf ball layers by conventional compression or injection molding techniques. Light stable polyureas and polyurethanes are preferred for the outer cover layer material. Preferably, the rubber core composition comprises a rubber, a crosslinking agent, a filler, a co-crosslinking agent or free radical initiator, and optionally a cis-to-trans catalyst. Typical rubber materials include natural and synthetic rubbers, including, but not limited to, polybutadiene and styrene-butadiene. The crosslinking agent typically includes a metal salt, such as a zinc salt or magnesium salt, of an acid having from 3 to 8 carbon atoms, such as (meth) acrylic acid. The free radical initiator can be any known polymerization initiator which decomposes during the cure cycle, including, but not limited to, dicumyl peroxide, 1,1-di-(t-butylperoxy) 3,3,5-trimethyl cyclohexane, a-a bis-(t-butylperoxy) diisopropylbenzene, 2,5-dimethyl-2,5 di-(t-butylperoxy) hexane or di-t-butyl peroxide, and mixtures thereof. Suitable types and amounts of rubber, crosslinking agent, filler, co-crosslinking agent, and initiator are more fully described in, for example, U.S. Patent Application Publication No. 2003/0144087, the entire disclosure of which is hereby incorporated herein by reference. Reference is also made to U.S. Patent Application Publication No. 2003/0144087 for various ball constructions and materials that can be used in golf ball core, intermediate, and cover layers.

In another preferred embodiment, the present invention provides a multi-layer golf ball having a solid core, an outer core layer, and a cover, wherein the outer core layer is formed from a composition comprising an HNP produced using a less hydrophilic cation source. In a particular aspect of this embodiment, the composition has a moisture vapor transmission rate of less than 8 g-mil/100 in²/day, thereby reducing the penetration of moisture into the core. In another particular aspect of this embodiment, the HNP is preferably based on an ethylene/(meth) acrylic acid copolymer, which may, but preferably does not, contain a softening comonomer. The solid core may be formed from any suitable core material, and is preferably formed from a conventional rubber selected from polybutadiene, polyisoprene, ethylene propylene rubber (“EPR”), ethylene propylene diene rubber (“EPDM”), styrenic block copolymer rubbers (such as SI, SIS, SB, SBS, SIBS, and the like, where “S” is styrene, “I” is isobutylene, and “B” is butadiene), butyl rubber, halobutyl rubber, copolymers of isobutylene and para-alkylstyrene, halogenated copolymers of isobutylene and para-alkylstyrene, natural rubber, copolymers of butadiene with acrylonitrile, polychloroprene, alkyl acrylate rubber, chlorinated isoprene rubber, and acrylonitrile chlorinated isoprene rubber. The diameter of the core is preferably from 1.40 inches to 1.55 inches. The cover is preferably a tough, cut-resistant material, selected from conventional golf ball cover materials based on the desired performance characteristics. The cover may comprise one or more layers, and preferably has an overall thickness of from 0.020 inches to 0.045 inches. Suitable cover materials include ionomer resins, blends of ionomer resins, thermoplastic and thermoset urethane, thermoplastic and thermoset urea, (meth)acrylic acid, thermoplastic rubber polymers, polyethylene, and synthetic or natural vulcanized rubber, such as balata. Additional suitable core and cover materials are disclosed, for example, in U.S. Patent Application Publication No. 2005/0164810, U.S. Pat. No. 5,919,100, and PCT Publications WO00/23519 and WO00/29129, the entire disclosures of which are hereby incorporated herein by reference.

In another preferred embodiment, the present invention provides a two-piece golf ball having a core and a cover, wherein the cover is formed from a composition comprising an HNP produced using a less hydrophilic cation source. The cover preferably has a material hardness of from 30 Shore D to 70 Shore D. The thickness of the cover is preferably from 0.020 inches to 0.350 inches, more preferably from 0.025 inches to 0.090 inches. The core is preferably a solid core formed from any suitable core material, and is preferably formed from a conventional rubber selected from polybutadiene, polyisoprene, ethylene propylene rubber (“EPR”), ethylene propylene diene rubber (“EPDM”), styrenic block copolymer rubbers (such as SI, SIS, SB, SBS, SIBS, and the like, where “S” is styrene, “I” is isobutylene, and “B” is butadiene), butyl rubber, halobutyl rubber, copolymers of isobutylene and para-alkylstyrene, halogenated copolymers of isobutylene and para-alkylstyrene, natural rubber, copolymers of butadiene with acrylonitrile, polychloroprene, alkyl acrylate rubber, chlorinated isoprene rubber, and acrylonitrile chlorinated isoprene rubber. In a preferred aspect of the present embodiment, the core is formed from a reaction product of a rubber, a crosslinking agent, a filler, a free radical initiator, and optionally a cis-to-trans catalyst. The diameter of the core is preferably from 1.00 inches to 1.63 inches. The core preferably has an Atti compression of less than 100.

In another preferred embodiment, the present invention provides a two-piece or multi-layer golf ball having a center formed from a composition comprising an HNP produced using a less hydrophilic cation source. The HNP is preferably based on an E/X/Y-type polymer. Preferably, the core has a material hardness of from 30 Shore D to 50 Shore D. The cover is preferably a tough, cut-resistant material, selected from conventional golf ball cover materials based on the desired performance characteristics. The cover may comprise one or more layers, and preferably has an overall thickness of from 0.020 inches to 0.045 inches. Suitable cover materials include, but are not limited to, ionomer resins, blends of ionomer resins, thermoplastic and thermoset urethane, thermoplastic and thermoset urea, (meth)acrylic acid, thermoplastic rubber polymers, polyethylene, and synthetic or natural vulcanized rubber, such as balata.

Golf balls of the present invention generally have a coefficient of restitution (“COR”) of at least 0.790, preferably at least 0.800, more preferably at least 0.805, and even more preferably at least 0.810, and an Atti compression of from 75 to 110, preferably from 90 to 100. As used herein, COR is defined as the ratio of the rebound velocity to the inbound velocity when balls are fired into a rigid plate. In determining COR, the inbound velocity is understood to be 125 ft/s.

When numerical lower limits and numerical upper limits are set forth herein, it is contemplated that any combination of these values may be used.

All patents, publications, test procedures, and other references cited herein, including priority documents, are fully incorporated by reference to the extent such disclosure is not inconsistent with this invention and for all jurisdictions in which such incorporation is permitted.

While the illustrative embodiments of the invention have been described with particularity, it will be understood that various other modifications will be apparent to and can be readily made by those of ordinary skill in the art without departing from the spirit and scope of the invention. Accordingly, it is not intended that the scope of the claims appended hereto be limited to the examples and descriptions set forth herein, but rather that the claims be construed as encompassing all of the features of patentable novelty which reside in the present invention, including all features which would be treated as equivalents thereof by those of ordinary skill in the art to which the invention pertains.

What is claimed is:

1. A golf ball having at least one layer formed from a polymer composition, wherein the polymer composition has a moisture vapor transmission rate (MVTR) of 8 g-mil/100 in²/day or less and comprises a highly neutralized acid polymer.

2. The golf ball of claim 1, wherein at least 90% of the acid groups of the highly neutralized acid polymer are neutralized.

3. The golf ball of claim 1, wherein the polymer composition has an MVTR of 5 g-mil/100 in²/day or less.

4. The golf ball of claim 1, wherein the highly neutralized acid polymer is a salt of an copolymer of an olefin, from 4 wt % to 35 wt % of an α,β-ethylenically unsaturated carboxylic acid, based on the total weight of the copolymer, and from 0 wt % to 50 wt % of a C₁-C₈ alkyl (meth) acrylate, based on the total weight of the copolymer.

5. The golf ball of claim 1, wherein the highly neutralized acid polymer is a blend of two or more independently selected highly neutralized acid polymers.

6. The golf ball of claim 1, wherein the highly neutralized acid polymer is produced by a process comprising contacting one or acid polymer(s) with a sufficient amount of a less hydrophilic cation source, in the presence of a melt flow modifier, to increase the level of neutralization of the acid copolymer(s) to at least 70%.

7. The golf ball of claim 6, wherein the cation source is selected from a metal ion or compound of an alkali metal, an alkaline earth metal, a transition metal, or a combination thereof, and wherein the cation source is less hydrophilic than magnesium.

8. The golf ball of claim 6, wherein the cation source selected from metal ions and compounds of potassium, cesium, calcium, barium, manganese, copper, zinc, and tin; silicone, silane, and silicate derivatives and complex ligands; and metal ions and compounds of rare earth elements.

9. The golf ball of claim 1, wherein the polymer composition is produced by a process comprising contacting one or more acid polymer(s) with an organic acid or a metal salt of an organic acid and a sufficient amount of a less hydrophilic cation source such that at least 70% of all acid functionalities present in the polymer composition are neutralized.

10. The golf ball of claim 9, wherein the acid polymer is partially neutralized prior to contacting with the less hydrophilic cation source.

11. The golf ball of claim 9, wherein the less hydrophilic cation source is selected from metal ions and compounds of potassium, cesium, calcium, barium, manganese, copper, zinc, and tin; silicone, silane, and silicate derivatives and complex ligands; and metal ions and compounds of rare earth elements.

12. The golf ball of claim 9, wherein the organic acid selected from the group consisting of aliphatic organic acids, aromatic organic acids, saturated mono-functional organic acids, unsaturated mono-functional organic acids, and multi-unsaturated mono-functional organic acids, salts thereof, and combinations thereof.

13. The golf ball of claim 9, wherein the organic acid is selected from the group consisting of caproic acid, caprylic acid, capric acid, lauric acid, stearic acid, behenic acid, erucic acid, oleic acid, linoleic acid, myristic acid, benzoic acid, palmitic acid, phenylacetic acid, naphthalenoic acid, dimerized derivatives thereof, salts thereof, and combinations thereof.

14. The golf ball of claim 9, wherein the metal of the organic acid salt is selected from the group consisting of alkali, alkaline earth, and transition elements, and wherein the metal ion is less hydrophilic than a magnesium ion.

15. The golf ball of claim 9, wherein the organic acid salt is produced using a cation source selected from metal ions and compounds of potassium, cesium, calcium, barium, manganese, copper, zinc, and tin; silicone, silane, and silicate derivatives and complex ligands; and metal ions and compounds of rare earth elements.

16. The golf ball of claim 1, wherein the golf ball comprises a core and a cover, wherein the cover is formed from said polymer composition, and wherein the core is formed from a reaction product of a rubber, a crosslinking agent, a filler, a free radical initiator, and optionally a cis-to-trans catalyst.

17. The golf ball of claim 16, wherein the core has an Atti compression of from 10 to 100, a surface hardness of from 20 Shore D to 70 Shore D, and a diameter of from 1.00 inches to 1.63 inches; and wherein the cover has a thickness of from 0.020 inches to 0.350 inches.

18. The golf ball of claim 1, wherein the golf ball comprises a core and a cover, wherein the core is formed from said polymer composition, and wherein the cover is formed from a material selected from the group consisting of ionomer resins, blends of ionomer resins, highly neutralized polymers, thermoplastic polyurethane, thermoset polyurethane, thermoplastic polyurea, thermoset polyurea, and blends thereof.

19. The golf ball of claim 1, wherein the golf ball comprises a core, a cover, and an intermediate layer disposed between the core and the cover, wherein the intermediate layer is formed from said polymer composition; and wherein the core is formed from a reaction product of a rubber, a crosslinking agent, a filler, a free radical initiator, and optionally a cis-to-trans catalyst.

20. A golf ball having at least one layer formed from a polymer composition having a moisture vapor transmission rate of 5 g-mil/100 in²/day or less and comprising at least 30 wt % of an ethylene/(meth) acrylic acid copolymer, based on the total polymeric weight of the polymer composition, wherein at least 90% of the acid groups of the acid copolymer are neutralized.
